(19) United States
(12) Patent Application Publication
(10) Pub. No.: US 2007/0093235 A1
(43) Pub. Date: Apr. 26, 2007

(54) METHOD AND APPARATUS FOR CALENDAR CALL FUNCTIONALITY

(75) Inventor: Jacob Kimbrell, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/163,487

(22) Filed: Oct. 20, 2005

(51) Int. Cl. H04L 12/58

(52) U.S. Cl. 455/412.1; 455/418

(57) ABSTRACT

The user selects a call number from a call number list. Once the entry is selected, the menu for the list management presents a “schedule call” option to the user. Selecting the “schedule call” option launches the interface application module between the call number list and the calendar functionality of the wireless terminal. The interface module automatically opens the calendar application and displays the calendar to the user. The interface module associates the selected call number with the calendared entry. When the calendared item is displayed, the call number stored in conjunction with that calendared item is also displayed such that a call to that number may be initiated simply by the user pressing the appropriate function button.

### BACKGROUND

The invention relates to calendar events such as are stored on mobile terminals and more particularly to a method and apparatus for coordinating calendar events with the mobile terminal call management functionality.

It will be appreciated that mobile terminals may include cellular phones, PCS phones, personal digital assistants, computers with wireless connectivity or the like where the mobile terminal may communicate with other terminals over a wireless network and the public switched telephone network, the internet, private networks or other networking facilities. The wireless terminal may be connected to the network over an air interface using GSM, CDMA, TDMA, GPRS, EDGE, UMTS or other standardized or proprietary transport as is known.

Many wireless terminals include a calendar function that allows the user to enter data into a calendar for a variety of stored events. The data may be entered into the wireless terminal directly by the user accessing the terminal's calendar functionality or the data may be entered from another device using a synchronization tool via an interface such as Bluetooth. The stored events may include the time and date of a calendar item, notes associated with the item, audio or visual reminders for the entry or the like.

Moreover, many wireless terminals include call management systems such as phone books, contacts lists and call lists. Phone books and contacts lists are typically created by the user and include the identity of an entity with a call number, such as a telephone number, for that entity and other entity related information. Call lists may be created automatically by the wireless terminal based on recent call events such as received calls, outgoing calls or the like where the call numbers may be stored in the wireless device and retrieved from the call lists by the user to initiate a call. Initiating a call using a number in a call list, contacts list or a phone book is known where the number can be highlighted by the user and a function button, such as a soft key pop-up button, pressed to connect a call to the highlighted number without the need for the user to re-input the digits of the highlighted number.

While such functionality is independently present in many wireless terminals there is a need to interface the functionality of phone books and call lists with the functionality of the calendar to enable the user to more efficiently make use of the combined calendar and call list functionality.

### SUMMARY OF THE INVENTION

In one embodiment of the invention, the user may select a phone book entry or call list entry. Once the entry is selected, the list management menu presents a number of menu options to the user that may include “Delete Contact”, “Edit Contact”, “Send Contact” or the like. In accordance with the invention an option “Schedule Call” is also presented to the user. Selecting the “schedule call” menu option launches the interface application module between the call number list and the calendar functionality of the wireless terminal. The interface module automatically opens the calendar application and displays the calendar to the user. The user schedules a call by selecting an appropriate day and time on the calendar as is known. The user may also enter other information such as appointment notes into the calendar. The interface module stores the selected call number as part of the calendared entry or establishes a link to the selected call number stored in the call list or phone book. The calendared entry is saved. At the time of the scheduled event, the wireless terminal displays the calendared item. The calendar may display the appointment automatically and/or may provide an audio or visual alarm to the user. When the calendared item is displayed, the call number stored in conjunction with that calendared item is also displayed such that a call to that call number may be initiated simply by the user pressing the appropriate function button.

The invention may also be implemented by accessing the calendar and scheduling an item on the calendar. When the calendar functionality is initiated a soft key is presented to the user allowing the user to access the phone book or call list. The user can then go to an entry in the phone book or call list and by selecting that call number, the call number is associated with the calendared event. When the calendared event is opened the user is presented with a function button for initiating a call to the call number as previously described.

### BRIEF DESCRIPTION OF DRAWINGS

FIG. 1 is a block schematic diagram of an example of a communications device including functionality in accordance with an embodiment of the present invention.

FIGS. 2 through 4 are flow charts illustrating the method for call list/calendar interface functionality in accordance with an embodiment of the present invention.

FIGS. 5 through 9 show screen shots illustrating embodiments of the user interfaces for the system of the invention.

### DETAILED DESCRIPTION

The following detailed description of preferred embodiments refers to the accompanying drawings, which illustrate specific embodiments of the invention. Other embodiments having different structures and operations do not depart from the scope of the present invention.

In the instant disclosure the terms contacts list and phone book are used interchangeably and refer to any data stored in a wireless terminal, or accessible via the wireless terminal, where an entity is identified, such as a person identified by name, where a call number is associated with that entity. The phone book is typically created by the user and may include additional information such as address, notes or the like. A call list refers to data stored in a wireless terminal, or accessible via the wireless terminal, where a call number is identified. Typically the call number is saved automatically by the wireless device and is based on outgoing called numbers, incoming received calls, unanswered calls or the like. A call list may include the identity of an entity along with the call number or it may only include the call number. The term “call number” is used to identify a string characters from which a connection may be established from the wireless terminal. The call number may be a phone number, a fax number, an internet address or other such character string.

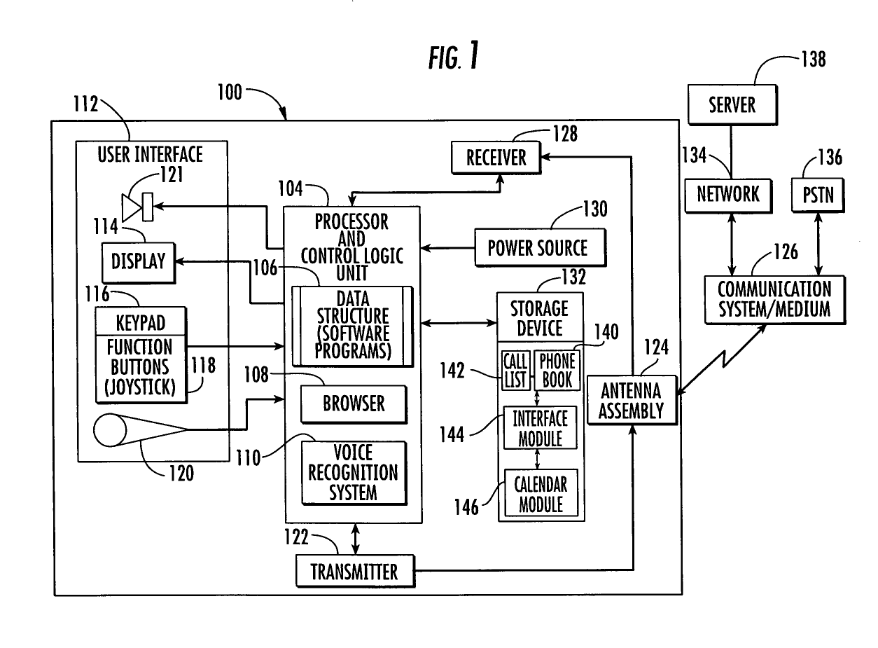

FIG. 1 is a block schematic diagram of an example of a communications device 100 including functionality in accordance with an embodiment of the present invention. The communications device 100 may include a processor and control logic unit 104. The processor and control logic unit 104 may be a microprocessor or the like. The processor and control logic unit 104 may include data structures or software programs 106 including computer-executable or computer-readable instructions to control operation of the communications device 100 and its components. The processor and control logic unit 104 may also include a browser 108 and voice recognition system 110.

The communications device 100 may include an operator or user interface 112 to facilitate controlling operation of the communications device 100 including initiating and conducting phone calls and other communications. The user interface 112 may include a display 114 to provide visual signals to a subscriber or user as to the status and operation of the communications device 100. The display 114 may be a liquid crystal display (LCD) or the like capable of presenting color images. The display 114 provides information to a user or operator in the form of images, text, numerals, characters, a graphical user interface (GUI) and the like. The user interface 112 may also include a keypad 116 and function keys or buttons 118 including a point device, such as a joystick or the like. The function buttons may comprise soft key pop-up menus. It is to be understood that a soft key pop-up menu comprises one or more menu entries or functions displayed on the display 114 where the menu entry can be selected by depressing a physical button or other device. The functions associated with the soft key pop menu are software controlled such that the functions can be changed for different applications. The keypad 116, function buttons and joystick 118 permit the user to communicate commands to the communications device 100 to dial phone numbers, initiate and terminate calls, establish other communications, such as access to the Internet, send and receive email, text messages and the like. The keypad 116, function buttons and joystick 118 may also be used to control the operation of the communications device 100 to enable the interface functionality of the invention.

The user interface 112 may also include a microphone 120 and a speaker 121. The microphone 120 may receive audio or acoustic signals from a user or from an acoustic source, such as a radio, television or the like. The microphone 120 may convert the audio or acoustic signals to electrical signals. The microphone 120 may be connected to the processor and logic unit 104 wherein the processor and logic unit 104 may convert the electrical signals to baseband communication signals. The processor and control logic unit 104 may be connected to a transmitter 122 that may convert baseband signals from the main processor and control logic unit 104 to radio frequency (RF) signals. The transmitter 122 may be connected to an antenna assembly 124 for transmission of the RF signals to a communication medium or system 126.

The antenna assembly 124 may receive RF signals over the air and transfer the RF signals to a receiver 128. The receiver 128 may convert the RF signals to baseband signals. The baseband signals may be applied to the processor and control logic unit 104 which may convert the baseband signals to electrical signals. The processor and control unit 104 may send the electrical signals to speaker 121, which may convert the electrical signals to audio signals that can be understood by the user.

A power source 130 may be connected to the processor and control logic unit 104 to provide power for operation of the communications device 100. The power source 130 may be a rechargeable battery or the like. The communications device 100 may also include at least one data storage device 132. The data storage device 132 may store lists of call numbers. Examples of the lists may include a phone book or contacts list 140 and stored in a phone book portion of the storage device 132, and/or a call list 142 including numbers for calls that have been missed or not answered or that have been called by the communications device 100 and the like and stored in a call list portion of storage device 132. The data storage device 132 may be a computer-readable medium to store computer-executable or computer-usable instructions or data structures, such as data structures 106, to perform special operations or functions such as those described in accordance with embodiments of the present invention.

The communications device 100 may be operable in association with a communications system or medium 126 in accordance with an embodiment of the present invention. The communications system or medium 126 may be a mobile, wireless, cellular communications system or similar system. The communications system 126 may couple the communications device 100 to another communication network 134 or to a public switched telephone network 136.

The communications device 100 may be a mobile terminal such as a cordless telephone, cellular telephone, personal digital assistant (PDA), communicator, computer device or the like and is not unique to any particular communication standard, such as Advanced Mobile Phone Service (AMPS), Digital Advanced Mobile Phone Service (D-AMPS), Global System for Mobile Communications (GSM), Code Division Multiple Access (CDMA), Time Division Multiple Access (TDMA) or the like. The layout and design illustrated in FIG. 1 is for purposes of explaining the present invention and the present invention is not limited to any particular design. While the communications device 100 illustrated in FIG. 1 is a mobile terminal, the present invention may also be applicable to wired or hard wired communication devices and systems.

It should be noted that computer program code in the form of various computer program instructions can be used to implement at least portions of the processes involved in carrying out embodiments of the invention. Such computer program code can be supplied via a computer program product containing all or a portion of the computer program instructions stored on a media. The media may be fixed, or removable. Such a media is conceptually illustrated at 132 of FIG. 1 as a fixed storage media, but it could also be a removable optical or magnetic disc or tape. The computer program instructions can reside on any medium that can contain, store, communicate, propagate, or transport computer program code for execution by any type of computing platform, instruction execution system, or collection of such systems interconnected via a bus or network. Such a computer readable medium may be, for example, but not limited to, an electronic, magnetic, optical, electromagnetic, infrared, or semiconductor system, device, or propagation medium. Other examples of the computer-readable medium would include an electrical connection having one or more wires, a portable computer diskette or portable fixed disk, an optical fiber, a compact disc read-only memory (CD-ROM), and a digital versatile disc read-only memory (DVD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Computer program instructions which implement all or a portion of the invention may also be embodied in a stream of information being retrieved over a network such as the Internet.

The term “module” is meant to refer to a specific process that is performed as part of the system discussed throughout. Often a module corresponds to a software application.

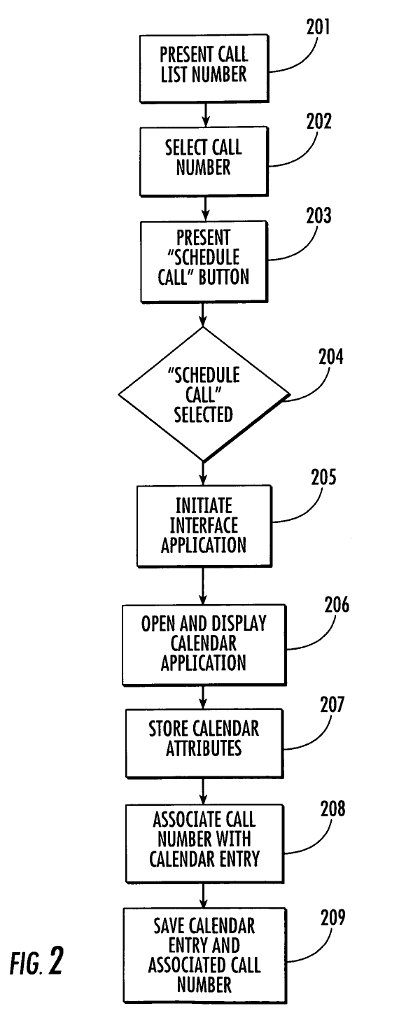

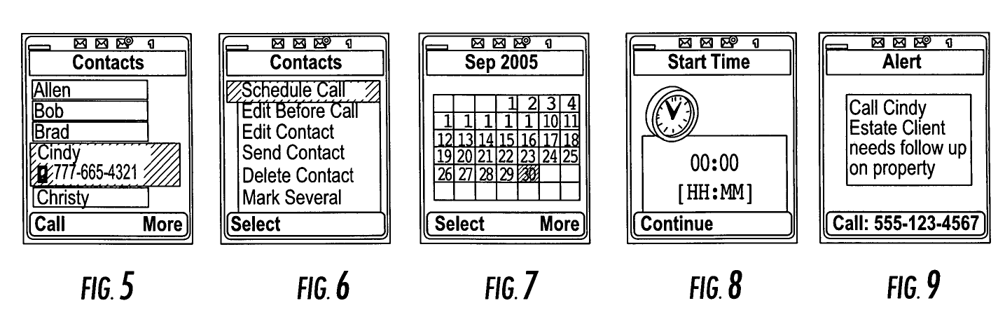

The operation of the system of the invention will now be explained with respect to FIGS. 1 and 2. In one operation of an embodiment of the invention, the user retrieves a phone book entry or call list entry stored in either the wireless device's internal storage 132 or from an external storage device such as a server 138 accessible over network 134. Specifically, the user, via a graphic user interface such as a soft key pop-up menu, is presented with a call number list such as stored in a phone book or call list as shown in FIG. 5 (block 201). Optionally, the desired call number may be entered into the phone book for the first time at this point in the operation of the system. One of the entries in the presented list is selected by the user (block 202). When the call number is selected a choice of menu options are presented that may be selected by the user. For example, the choices may include “Delete Contact”, “Edit Contact”, “Send Contact” or the like as is known in the art. One of the menu choices presented to the user is “Schedule Call” as shown in FIG. 6 (block 203). When the user selects “schedule call” (block 204), the interface application module 144 is launched in processor and control logic unit 104 (block 205). The interface module 144 opens the calendar application module 146 of the wireless terminal that is displayed to the user on display 114 as shown in FIG. 7 (block 206). Attributes such as day and time of appointment, notes, alerts or the like are entered by the user and stored in the calendar application module 146 through a user interface such as shown in FIG. 8 (block 207). The interface application module 144 associates the selected call number with the calendared entry (block 208). To associate the call number with the calendared event, the call number may be copied and stored in the calendar application module 146 by the interface module 144. Alternatively, the interface module 144 may establish a link between the calendar module 146 and the selected number in the call list 142 or phone book 144. The calendared entry is saved (block 209).

Referring to FIG. 3, at the time of the calendared event, the wireless terminal will display the calendared item at display 114 (block 301). The calendared item may be displayed by the user accessing the calendar function and manually accessing the desired date and time. Alternatively, the mobile terminal 100 may automatically display the calendared item and present the user with an audible or visual alert. When the calendared item is displayed, the call number associated with that calendared item is also displayed as shown in FIG. 9 (block 302). A connection to the call number is initiated by selecting the displayed call number such as by pressing a “Send” function button (block 303). The connection to the call number is initiated by pressing the “Send” function button without the need to input the call number character string.

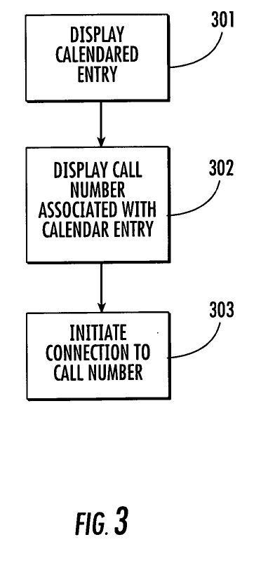

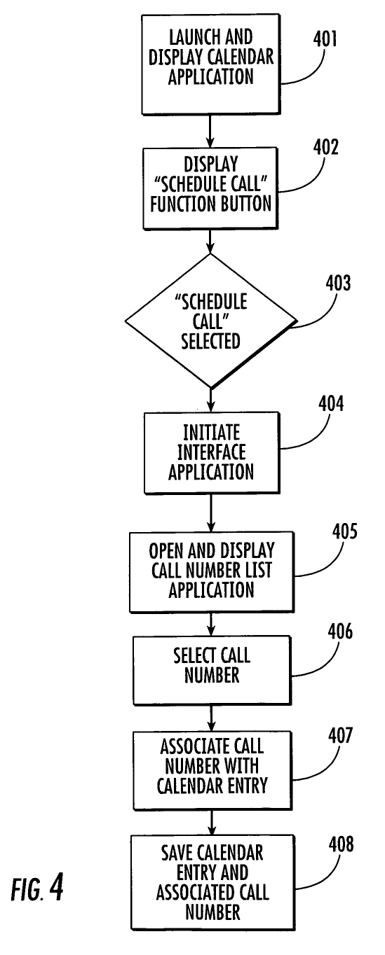

Referring to FIG. 4 the schedule call interface may also be accessed from the calendar module 146. The calendar module 146 is launched and displayed on display 114 (block 401). When the calendar module 146 is initiated, the user may enter calendared events such as the appointment day and time, notes, alerts or the like to create an appointment as is known in the art. The calendar module 146 may present “Schedule Call—Call List” and “Schedule Call—Phone Book” function buttons on display 114 to the user (block 402). Selecting one of the “schedule call” buttons (block 403) launches the interface application module 144 (block 404). The interface application module 144 automatically opens the phone book 140 or the call list 142 and presents it on display 114 (block 405). The user can then access the phone book or call list on display 114 and select an entry in the phone book or call list (block 406). The interface application module 144 automatically associates the selected call number with the calendared appointment (block 407). A link may be established by the interface module 144 to the call number from the calendar module 146 or the call number may be copied and saved as part of the data saved by calendar module 146 for the appointment entry. The calendar entry is saved (block 408).

When the calendared event is subsequently opened the user is presented with a “Send” function button for initiating a call to the linked number as previously described with respect to FIG. 3. The user can initiate a connection to the selected call number without the need to look up and manually enter the number characters by pressing the “Send” function button.

Specific embodiments of an invention are disclosed herein. One of ordinary skill in the art will recognize that the invention has other applications in other environments. For example, the function buttons have been described with specific labels such as “Send”. It will be understood that the buttons may be labeled with other descriptors provided that the functionality of the button corresponds to the functionality of the button as described herein. Many embodiments are possible. The following claims are in no way intended to limit the scope of the invention to the specific embodiments described above.

What is claimed is:

1. A method of call management on a wireless terminal comprising:
retrieving a call number;
initiating an interface between the call number and a calendar;
launching the calendar functionality of the wireless terminal;
entering data using the calendar functionality;
associating the call with the calendared entry;
displaying the call number with the calendared entry; and
initiating a connection with the call number without entering the call number.

2. The method of claim 1 wherein the call number is retrieved from a call list.

3. The method of claim 1 wherein the call number is retrieved from a contacts list.

4. The method of claim 1 wherein the call number is stored on said wireless terminal.

5. The method of claim 1 wherein the call number is stored remote from the wireless terminal.

6. The method of claim 1 wherein associating the call number includes saving the call number with the calendared entry.

7. The method of claim 1 wherein associating the call number includes establishing a link to the number.

8. The method of claim 1 wherein the initiating a connection comprises using a soft key.

9. A method of call management on a wireless terminal comprising:
initiating an interface between a call number and a calendar;
storing an appointment in the calendar;
associating the call number with the calendared entry;
displaying the call number with the calendared entry; and
calling the call number without entering the call number.

10. A method of call management on a wireless terminal comprising:
launching the calendar functionality of the wireless terminal;
entering data using the calendar functionality;
providing a menu option to schedule a call;
initiating an interface between the calendar and a call number list in response to activation of the option to schedule a call;
retrieving a call number from the call number list;
associating the call with the calendared entry;
displaying the call number with the calendared entry; and
initiating a connection with the call number without entering the call number.

11. A wireless terminal comprising:
an interface application between a call number list and a calendar function;
a link between the call number and a calendared entry;
a display for displaying the call number with the calendared entry; and
a function button for initiating a call to the call number without entering the call number.

12. The wireless terminal of claim 12 wherein the wireless device is a cell phone.

13. The wireless terminal of claim 12 wherein the wireless device is a computer.

14. The wireless terminal of claim 12 wherein the function button is a soft key button with a pop-up menu.

15. The wireless terminal of claim 12 wherein the call number is a phone number.

16. The wireless terminal of claim 12 wherein the call number is an internet address.

17. A wireless terminal comprising:
an interface application between a call number list and a calendar function;
a storage device for storing the call number with a calendared entry;
a display for displaying the call number with the calendared entry; and
a function button for initiating a call to the call number without entering the call number.

18. The wireless terminal of claim 18 wherein the function button is a soft key button with a pop-up menu.
